(19) United States
(12) Patent Application Publication
(10) Pub. No.: US 2014/0344493 A1
(43) Pub. Date: Nov. 20, 2014

(54) USB INTERFACE DETECTION DEVICE

(71) Applicant: Primax Electronics Ltd., Taipei (TW)

(72) Inventor: CHANG-YUNG FENG, Taipei (TW)

(73) Assignee: Primax Electronics Ltd., Taipei (TW)

(21) Appl. No.: 14/049,976

(22) Filed: Oct. 9, 2013

(30) Foreign Application Priority Data
May 17, 2013 (TW) 102117544

(51) Int. Cl. G06F 13/40

(52) U.S. Cl. CPC G06F 13/4081
USPC 710/302

(57) ABSTRACT

A USB interface detection device is provided. The USB interface detection device includes a USB cable and a detection unit. A first electrical plug and a second electrical plug of the USB cable are plugged into a first electrical receptacle of a first electrical device and a second electrical receptacle of a second electrical device, respectively. A USB3.0 GND_DRAIN pin of the first electrical plug is connected with an ID pin of the second electrical plug. A first VBUS pin of the first electrical plug is connected with a second VBUS pin of the second electrical plug. The detection unit is disposed within the second electrical device for detecting a voltage difference between the said second VBUS pin and the ID pin, thereby judging an interface specification of the first electrical receptacle.

### FIELD OF THE INVENTION

The present invention relates to a USB technology, and more particularly to a USB interface detection method and a USB interface detection device with a USB cable.

### BACKGROUND OF THE INVENTION

With increasing development of information technologies, portable electronic devices become more and more popular. Since the current computer system has powerful multimedia processing functions, various portable electronic devices can be directly in communication with the computer system to perform various data transmitting tasks. As known, a universal serial bus (USB) interface is one of the most popular connecting interfaces between the portable electronic device and the computer system. The reason is that the USB interface has many benefits such as the plug and play capability, the hot plug capability, the high transmission speed, and the like.

More especially, the universal serial bus also has the function of transferring a current. Consequently, the computer system may provide electrical energy to the portable electronic device through the USB interface. By acquiring the electrical energy, the portable electronic device can be normally operated. Alternatively, the computer system may provide the electrical energy to charge a lithium battery of the portable electronic device. Generally, in case that the USB interface is a USB2.0 interface, the computer system is able to provide a current of about 500 mA to the portable electronic device. Whereas, in case that the USB interface is a USB3.0 interface, the computer system is able to provide a current of about 900 mA to the portable electronic device. Consequently, if the computer system has an USB3.0 interface, the lithium battery of the portable electronic device may be charged at a high charging speed.

Moreover, when the portable electronic device is in communication with the computer system through a USB cable, the portable electronic device may firstly judge the interface specification of the computer system and then request the computer system to provide a corresponding current. In accordance with a conventional method of judging the interface specification of the computer system, an inquiring signal is firstly transmitted from the portable electronic device to the computer system through a universal serial bus. In response to the inquiring signal, a feedback signal is outputted from the computer system to the portable electronic device. According to the feedback signal, the portable electronic device can judge the interface specification of the computer system. If the portable electronic device judges that the interface specification of the computer system is the USB3.0 interface, the portable electronic device will request the computer system to provide the current of about 900 mA. Whereas, if the portable electronic device judges that the interface specification of the computer system is the USB2.0 interface, the portable electronic device will request the computer system to provide the current of about 500 mA.

From the above discussions, after the inquiring signal is transmitted from the portable electronic device to the computer system and then the feedback signal is outputted from the computer system to the portable electronic device, the portable electronic device may judge the interface specification of the computer system according to the feedback signal. In other words, the conventional method of judging the interface specification of the computer system is time-consuming. Moreover, for implementing the conventional judging method, the portable electronic device should comprise complicated integrated circuits and wires. Under this circumstance, the fabricating cost of the portable electronic device is increased.

### SUMMARY OF THE INVENTION

The present invention provides a USB interface detection device with a USB cable in order to quickly judge a specification of a USB interface which is plugged by the USB cable.

In accordance with an aspect of the present invention, there is provided a USB interface detection device. The USB interface detection device includes a USB cable and a detection unit. The USB cable includes a first electrical plug and a second electrical plug. The first electrical plug may be plugged into a first electrical receptacle of a first electrical device. The first electrical plug includes a first VBUS pin and a USB3.0 GND_DRAIN pin. The second electrical plug may be plugged into a second electrical receptacle of a second electrical device. The second electrical plug includes a second VBUS pin and an ID pin. The second VBUS pin is connected with the first VBUS pin. The ID pin is connected with the USB3.0 GND_DRAIN pin. The detection unit is disposed within the second electrical device. When the first electrical plug is plugged into the first electrical receptacle and the second electrical plug is plugged into the second electrical receptacle, the detection unit judges an interface specification of the first electrical receptacle by detecting a voltage value of the second VBUS pin and a voltage value of the ID pin, or the detection unit judges the interface specification of the first electrical receptacle by detecting a voltage difference between the second VBUS pin and the ID pin.

In accordance with another aspect of the present invention, there is provided a USB interface detection method for detecting an interface specification of a first electrical receptacle of a first electrical device when the first electrical device is in communication with a second electrical device. The USB interface detection method includes the following steps. Firstly, a USB cable is provided. The USB cable includes a first electrical plug and a second electrical plug. The first electrical plug includes a first VBUS pin and a USB3.0 GND_DRAIN pin. The second electrical plug includes a second VBUS pin and an ID pin. The first VBUS pin and the second VBUS pin are connected with each other. The USB3.0 GND_DRAIN pin and the ID pin are connected with each other. When the first electrical plug is plugged into the first electrical receptacle of the first electrical device and the second electrical plug is plugged into the second electrical receptacle of the second electrical device, an interface specification of the first electrical receptacle is judged by detecting a voltage value of the second VBUS pin and a voltage value of the ID pin, or the interface specification of the first electrical receptacle is judged by detecting a voltage difference between the second VBUS pin and the ID pin.

In accordance with a further aspect of the present invention, there is provided a USB cable. The USB cable includes a first electrical plug and a second electrical plug. The first electrical plug may be plugged into a first electrical receptacle of a first electrical device. The first electrical plug includes a first VBUS pin and a USB3.0 GND_DRAIN pin. The second electrical plug may be plugged into a second electrical receptacle of a second electrical device. The second electrical plug includes a second VBUS pin and an ID pin. The first VBUS pin and the second VBUS pin are connected with each other. The USB3.0 GND_DRAIN pin and the ID pin are connected with each other.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a USB cable according to an embodiment of the present invention;

FIG. 2 is a schematic view illustrating a first electrical plug of the USB cable of FIG. 1;

FIG. 3 is a schematic view illustrating a second electrical plug of the USB cable of FIG. 1;

FIG. 4 is a schematic view illustrating a USB interface detection device according to a first embodiment of the present invention;

FIG. 5 is a schematic view illustrating a USB interface detection device according to a second embodiment of the present invention;

FIG. 6 is a schematic view illustrating a USB interface detection device according to a third embodiment of the present invention; and

FIG. 7A-7B are flowchart illustrating a USB interface detection method according to an embodiment of the present invention.

### DETAILED DESCRIPTION OF THE PREFERRED EMBODIMENT

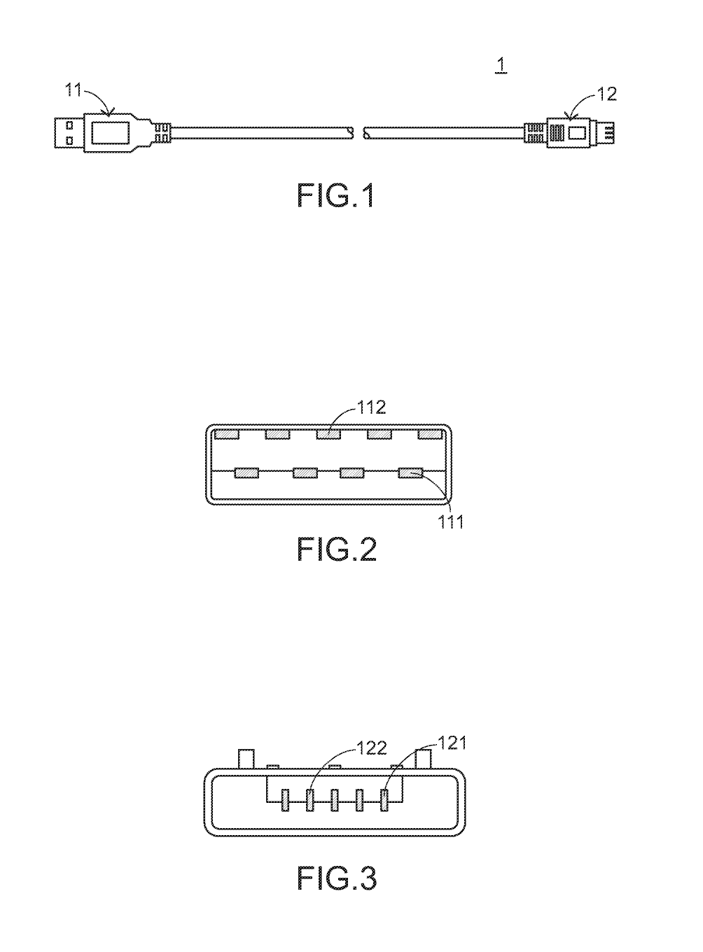

Please refer to FIGS. 1, 2 and 3. FIG. 1 is a schematic view illustrating a USB cable according to an embodiment of the present invention. FIG. 2 is a schematic view illustrating a first electrical plug of the USB cable of FIG. 1. FIG. 3 is a schematic view illustrating a second electrical plug of the USB cable of FIG. 1.

The USB cable 1 comprises a first electrical plug 11 and a second electrical plug 12. The first electrical plug 11 has a first VBUS pin 111 and a USB3.0 GND_DRAIN pin 112. The second electrical plug 12 has a second VBUS pin 121 and an ID pin 122. The first VBUS pin 111 and the second VBUS pin 121 are connected with each other. The USB3.0 GND_DRAIN pin 112 and the ID pin 122 are connected with each other.

In this embodiment, the first electrical plug 11 is an electrical plug having a USB interface complying with the A-type USB3.0 specification, and second electrical plug 12 is an electrical plug having a USB interface complying with the B-type Micro USB2.0 specification, but is not limited thereto. Moreover, the USB3.0 GND_DRAIN pin 112 is the seventh pin or the eighth pin of the first electrical plug 11, and the ID pin 122 is the fourth pin of the second electrical plug 12, but is not limited thereto.

The first electrical plug 11 may be any other electric plug with the first VBUS pin 111 and the USB3.0 GND_DRAIN pin 112. For example, the first electrical plug 11 may be an electrical plug having a USB interface complying with the B-type USB3.0 specification, an electrical plug having a USB interface complying with the A-type Micro USB3.0 specification, an electrical plug having a USB interface complying with the AB-type Micro USB3.0 specification or an electrical plug having a USB interface complying with the B-type Micro USB3.0 specification. Generally, the USB3.0 GND_DRAIN pin 112 is the seventh pin or the eighth pin of the electrical plug.

The second electrical plug 12 may be any other electric plug with the second VBUS pin 121 and the ID pin 122. For example, the second electrical plug 12 may be an electrical plug having a USB interface complying with the A-type Micro USB2.0 specification, a USB interface complying with the AB-type Micro USB2.0 specification, a USB interface complying with the A-type Mini USB2.0 specification, a USB interface complying with the B-type Mini USB2.0 specification, a USB interface complying with the AB-type Mini USB2.0 specification, an electrical plug having a USB interface complying with the A-type Micro USB3.0 specification, an electrical plug having a USB interface complying with the AB-type Micro USB3.0 specification, or an electrical plug having a USB interface complying with the B-type Micro USB3.0 specification.

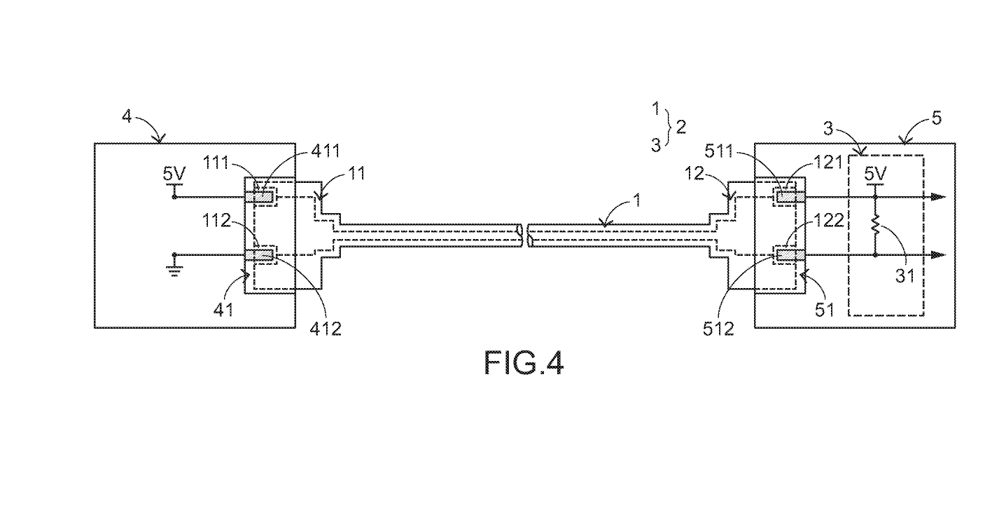

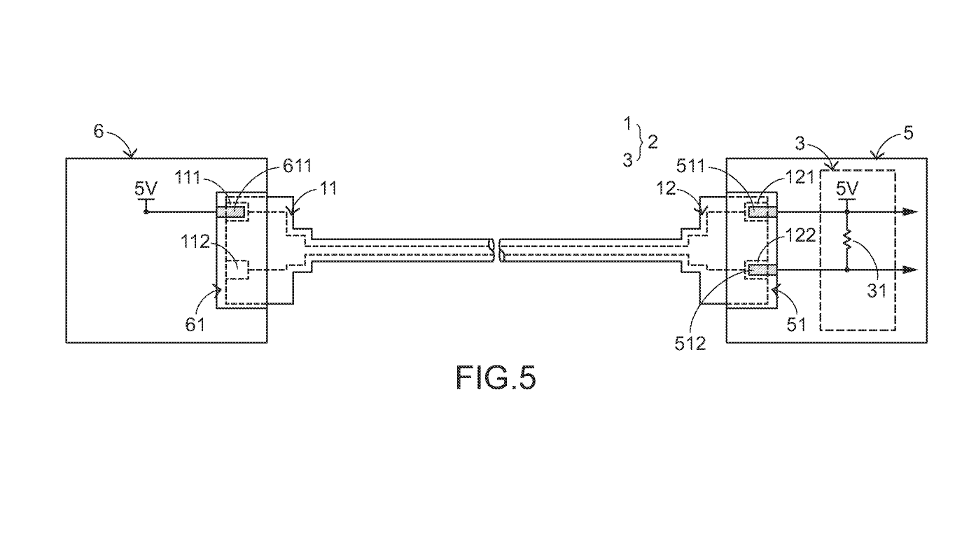

Hereinafter, a USB interface detection device of the present invention will be illustrated in more details. The USB interface detection device is used for quickly judging a specification of a USB interface which is plugged by the USB cable. For understanding the judging principles of the USB interface detection device of the present invention, three examples of the USB interface detection device will be illustrated in FIGS. 4, 5 and 6. In FIGS. 4, 5 and 6, the USB interfaces plugged by the USB cable are a USB3.0 interface, a USB2.0 interface, and a USB power adapter plug interface, respectively.

FIG. 4 is a schematic view illustrating a USB interface detection device according to a first embodiment of the present invention. As shown in FIG. 4, the USB interface detection device 2 comprises a detection unit 3 and a USB cable 1 as shown in FIG. 1. The first electrical plug 11 of the USB cable 1 is plugged into a first electrical receptacle 41 of a first electrical device 4. The second electrical plug 12 of the USB cable 1 is plugged into a second electrical receptacle 51 of a second electrical device 5. In this embodiment, the first electrical device 4 is a current-providing device, for example a computer system with a USB3.0 device port. The second electrical device 5 is a power-receiving device such as a data storage device (e.g. a portable flash drive), an image processing device (e.g. a scanner or a camera) or an electrical energy storage device.

The first electrical receptacle 41 has a first VBUS pin 411 connected with the first VBUS pin 111 and a USB3.0 GND_DRAIN pin 412 connected with the USB3.0 GND_DRAIN pin 112. Those skilled in the art will readily observe that the interface specification of the first electrical receptacle 41 with the first VBUS pin 411 and the USB3.0 GND_DRAIN pin 412 is an A-type USB3.0 interface, a B-type USB3.0 interface, an A-type Micro USB3.0 interface, a B-type Micro USB3.0 interface or an AB-type Micro USB3.0 interface, but is not limited thereto. Generally, the USB3.0 GND_DRAIN pin 412 is the seventh pin or the eighth pin of the first electrical receptacle 41, but is not limited thereto.

The second electrical receptacle 51 has a second VBUS pin 511 connected with the second VBUS pin 121 and an ID pin 512 connected with the ID pin 122. Those skilled in the art will readily observe that the interface specification of the second electrical receptacle 51 with the second VBUS pin 511 and the ID pin 512 is an A-type Micro USB2.0 interface, a B-type Micro USB2.0 interface, an AB-type Micro USB2.0 interface, an A-type Mini USB2.0 interface, a B-type Mini USB2.0 interface, an AB-type Mini USB2.0 interface, an A-type Micro USB3.0 interface, a B-type Micro USB3.0 interface or an AB-type Micro USB3.0 interface, but is not limited thereto. Generally, the ID pin 512 is the fourth pin of the second electrical receptacle 51, but is not limited thereto.

The detection unit 3 is disposed within the second electrical device 5. When the first electrical plug 11 is plugged into the first electrical receptacle 41 and the second electrical plug 12 is plugged into the second electrical receptacle 51, the detection unit 3 detects a voltage value of the second VBUS pin 121 and a voltage value of the ID pin 122 to judge an interface specification of the first electrical receptacle 41, or the detection unit 3 detects a voltage difference between the second VBUS pin 121 and a voltage value of the ID pin 122 to judge the interface specification of the first electrical receptacle 41. Moreover, an example of the detection unit 3 includes but is not limited to a micro control unit (MCU) or a combinational circuit. The micro control unit (MCU) or the combinational circuit is electrically connected with the second VBUS pin 511 and the ID pin 512.

In particular, when the first electrical plug 11 and the second electrical plug 12 of the USB cable 1 are respectively plugged into the first electrical receptacle 41 and the second electrical receptacle 51, the first VBUS pin 411, the first VBUS pin 111, the second VBUS pin 121 and the second VBUS pin 511 have the same voltage level. In addition, the USB3.0 GND_DRAIN pin 412, the USB3.0 GND_DRAIN pin 112, the ID pin 122 and the ID pin 512 have the same voltage level. Since the voltage value of the first VBUS pin 411 is 5V and the voltage value of the USB3.0 GND_DRAIN pin 412 is 0V, the voltage value of the second VBUS pin 121 is 5V and the voltage value of the ID pin 122 is 0V. In addition, a voltage difference between the second VBUS pin 511 and the ID pin 512 is 5V. That is, the voltage difference between the second VBUS pin 121 and the ID pin 122 of the second electrical plug 12 is 5V.

From the above discussions, if the detection unit 3 detects that the voltage difference between the second VBUS pin 121 and the ID pin 122 of the second electrical plug 12 is 5V, or if the detection unit 3 detects that the voltage value of the second VBUS pin 121 is 5V and the voltage value of the ID pin 122 is 0V, the detection unit 3 judges that the interface specification of the first electrical receptacle 41 is a USB3.0 interface.

FIG. 5 is a schematic view illustrating a USB interface detection device according to a second embodiment of the present invention. As shown in FIG. 5, the USB interface detection device 2 comprises a detection unit 3 and a USB cable 1 as shown in FIG. 1. The first electrical plug 11 of the USB cable 1 is plugged into a first electrical receptacle 61 of a first electrical device 6. The second electrical plug 12 of the USB cable 1 is plugged into a second electrical receptacle 51 of a second electrical device 5. The USB interface detection device 2, the second electrical device 5 and the second electrical receptacle 51 of this embodiment are similar to those of the first embodiment, and are not redundantly described herein.

In this embodiment, the first electrical device 6 is a current-providing device, for example a computer system with a USB2.0 device port. Moreover, the first electrical receptacle 61 has only a first VBUS pin 611 to be connected with the first VBUS pin 111, but the first electrical receptacle 61 does not have a USB3.0 GND_DRAIN pin to be connected with the USB3.0 GND_DRAIN pin 112. Those skilled in the art will readily observe that the interface specification of the first electrical receptacle 61 with only the first VBUS pin 611 but without a USB3.0 GND_DRAIN pin is an A-type USB2.0 interface, a B-type USB2.0 interface, an A-type Micro USB2.0 interface, a B-type Micro USB2.0 interface, an AB-type Micro USB2.0 interface, an A-type Mini USB2.0 interface, a B-type Mini USB2.0 interface or an AB-type Mini USB2.0 interface, but is not limited thereto.

When the first electrical plug 11 and the second electrical plug 12 of the USB cable 1 are respectively plugged into the first electrical receptacle 61 and the second electrical receptacle 51, the first VBUS pin 611, the first VBUS pin 111, the second VBUS pin 121 and the second VBUS pin 511 have the same voltage level. In addition, the USB3.0 GND_DRAIN pin 112, the ID pin 122 and the ID pin 512 have the same voltage level. Since the USB3.0 GND_DRAIN pin 112 is in a floating state but the USB3.0 GND_DRAIN pin 112 is electrically connected with the detection unit 3 of the second electrical device 5 through the USB cable 1, the voltage values of the USB3.0 GND_DRAIN pin 112, the ID pin 122 and the ID pin 512 are all 5V. Moreover, since the voltage value of the first VBUS pin 611 is 5V, the voltage difference between the second VBUS pin 511 and the ID pin 512 is 0V. That is, the voltage difference between the second VBUS pin 121 and the ID pin 122 of the second electrical plug 12 is 0V.

From the above discussions, if the detection unit 3 detects that the voltage difference between the second VBUS pin 121 and the ID pin 122 of the second electrical plug 12 is 0V, or if the detection unit 3 detects that the voltage values of the second VBUS pin 121 and the ID pin 122 are both 5V, the detection unit 3 judges that the interface specification of the first electrical receptacle 61 is a USB2.0 interface.

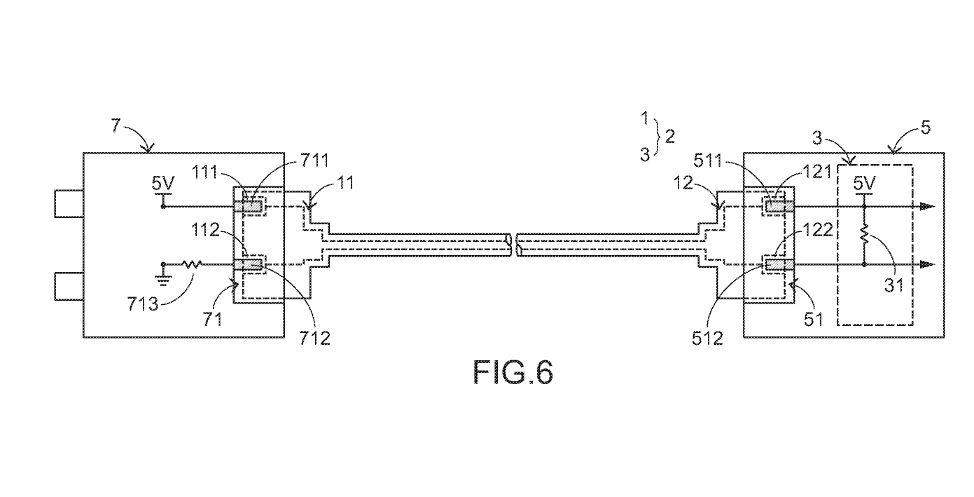

FIG. 6 is a schematic view illustrating a USB interface detection device according to a third embodiment of the present invention. As shown in FIG. 6, the USB interface detection device 2 comprises a detection unit 3 and a USB cable 1 as shown in FIG. 1. The first electrical plug 11 of the USB cable 1 is plugged into a first electrical receptacle 71 of a first electrical device 7. The second electrical plug 12 of the USB cable 1 is plugged into a second electrical receptacle 51 of a second electrical device 5. The USB interface detection device 2, the second electrical device 5 and the second electrical receptacle 51 of this embodiment are similar to those of the first embodiment, and are not redundantly described herein.

In this embodiment, the first electrical device 7 is a USB dedicated charging port (DCP). For example, the first electrical device 7 is a USB power adapter plug (i.e. a USB dedicated charger) to be plugged into a utility power socket. Moreover, the interface specification of the first electrical receptacle 71 of the first electrical device 7 is an USB power adapter plug interface. The first electrical receptacle 71 has a first VBUS pin 711 to be connected with the first VBUS pin 111 and a USB3.0 GND_DRAIN pin 712 to be connected with the USB3.0 GND_DRAIN pin 112. Moreover, a combinational circuit that is connected with the USB3.0 GND_DRAIN pin 712 and includes a resistor 713 is disposed within the first electrical device 7. The detection unit 3 is a combinational circuit including a resistor 31. Consequently, the voltage value of the USB3.0 GND_DRAIN pin 712 is determined according to the resistance value of the resistor 713 and the resistance value of the resistor 31.

When the first electrical plug 11 and the second electrical plug 12 of the USB cable 1 are respectively plugged into the first electrical receptacle 71 and the second electrical receptacle 51, the first VBUS pin 711, the first VBUS pin 111, the second VBUS pin 121 and the second VBUS pin 511 have the same voltage level. In addition, the USB3.0 GND_DRAIN pin 712, the USB3.0 GND_DRAIN pin 112, the ID pin 122 and the ID pin 512 have the same voltage level. Since the voltage value of the first VBUS pin 711 is 5V and the voltage value of the USB3.0 GND_DRAIN pin 712 is determined according to the resistance value of the resistor 713 and the resistance value of the resistor 31, the voltage difference between the second VBUS pin 511 and the ID pin 512 is equal to a preset voltage value corresponding to the resistance value of the resistor 713 and the resistance value of the resistor 31. That is, the voltage difference between the second VBUS pin 121 and the ID pin 122 of the second electrical plug 12 is equal to the preset voltage value. In an embodiment, the resistance value of the resistor 713 and the resistance value of the resistor 31 are both 10K ohms, and thus the preset voltage value (i.e. a division voltage value) is 2.5V. It is noted that the resistance value of the resistor 713 and the resistance value of the resistor 31 are not restricted. Those skilled in the art will readily observe that numerous modifications and alterations may be made according to the practical requirements. For example, in another embodiment, the resistance value of the resistor 31 is kept unchanged, but the resistance value of the resistor 713 may be varied. Under this circumstance, the preset voltage value is adjustable.

From the above discussions, if the detection unit 3 detects that the voltage difference between the second VBUS pin 121 and the ID pin 122 of the second electrical plug 12 is equal to the preset voltage value, the detection unit 3 judges that the interface specification of the first electrical receptacle 71 is an USB power adapter plug interface. That is, the detection unit 3 judges that first electrical receptacle 71 is an electrical receptacle within an USB power adapter plug.

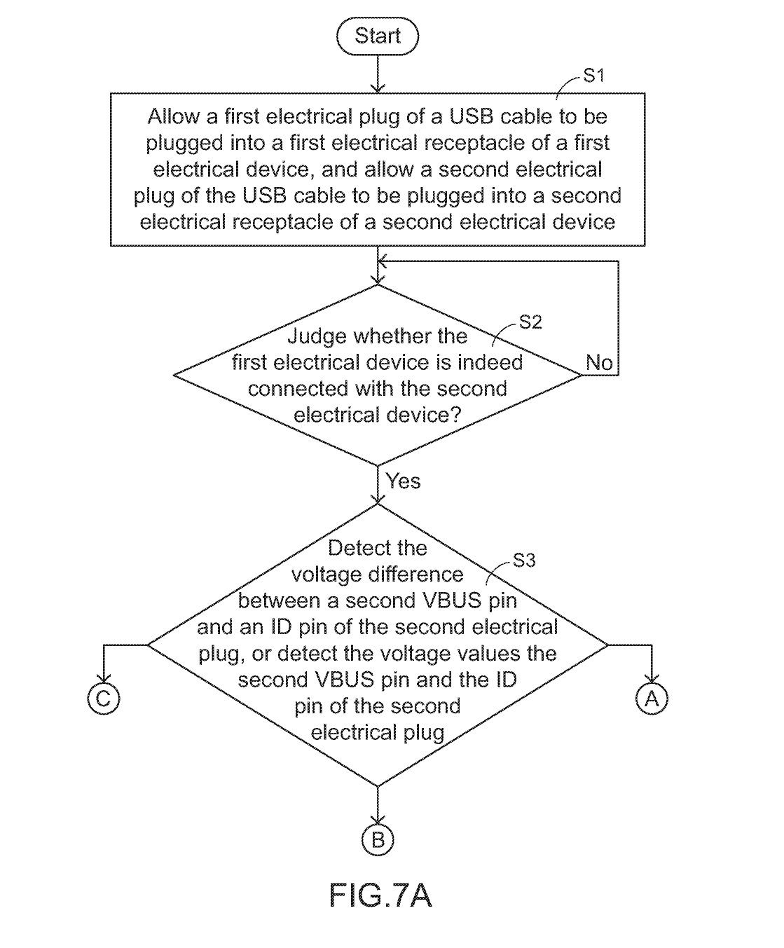

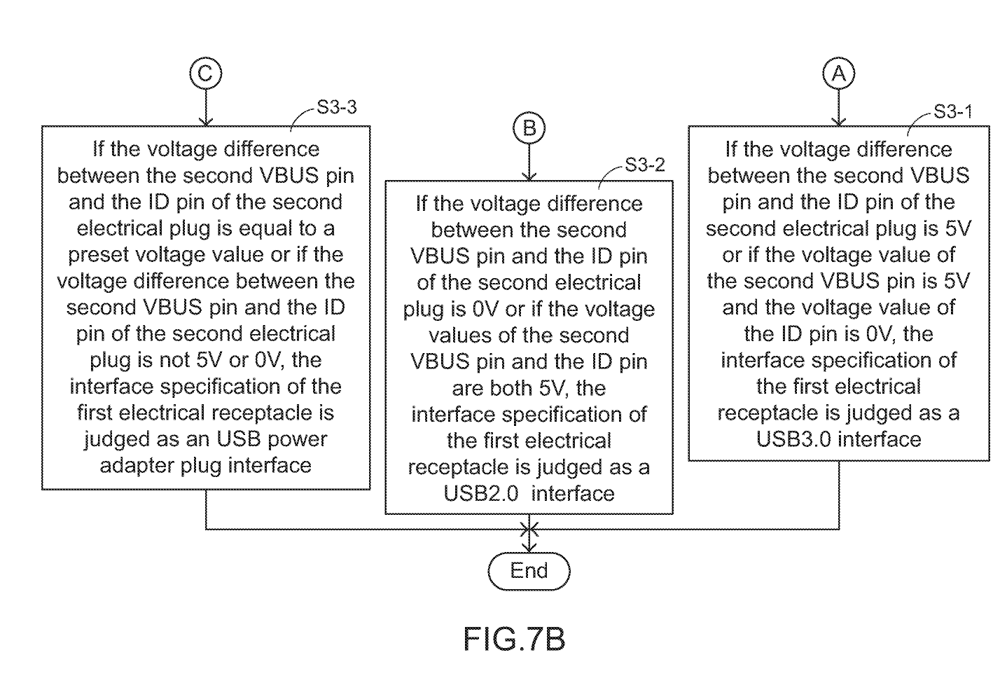

From the above descriptions, the present invention provides a USB interface detection method. FIG. 7A-7B are flowchart illustrating a USB interface detection method according to an embodiment of the present invention. Firstly, in the step S1, the first electrical plug 11 of the USB cable 1 is plugged into the first electrical receptacle of the first electrical device and the second electrical plug 12 of the USB cable 1 is plugged into the second electrical receptacle 51 of the second electrical device 5.

Then, the step S2 is performed to judge whether the first electrical device is indeed connected with the second electrical device 5. In particular, the detection unit 3 may judge whether the first electrical device and the second electrical device are indeed connected with each other by detecting the voltage value of the second VBUS pin 511 of the second electrical device 5.

That is, if the detection unit 3 detects that the voltage value of the second VBUS pin 511 of the second electrical device 5 is 5V (i.e. the second VBUS pin 121 of the second electrical plug 12 is 5V), the detection unit 3 judges that the first electrical device has been connected with the second electrical device 5. On the other hand, if the detection unit 3 detects that the voltage value of the second VBUS pin 511 of the second electrical device 5 is 0V (i.e. the second VBUS pin 121 of the second electrical plug 12 is 0V), the detection unit 3 judges that the first electrical device is not connected with the second electrical device 5, and the step S1 is repeatedly done.

Then, in the step S3, the detection unit 3 judges an interface specification of the first electrical receptacle by detecting the voltage values of the second VBUS pin 121 and the ID pin 122 of the second electrical plug 12, or the detection unit 3 judges the interface specification of the first electrical receptacle by detecting the voltage difference between the second VBUS pin 121 and the ID pin 122 of the second electrical plug 12.

In particular, if the voltage difference between the second VBUS pin 121 and the ID pin 122 of the second electrical plug 12 is 5V or if the voltage value of the second VBUS pin 121 is 5V and the voltage value of the ID pin 122 is 0V, the interface specification of the first electrical receptacle is judged as a USB3.0 interface (e.g. the step S3-1). If the voltage difference between the second VBUS pin 121 and the ID pin 122 of the second electrical plug 12 is 0V or if the voltage values of the second VBUS pin 121 and the ID pin 122 are both 5V, the interface specification of the first electrical receptacle is judged as a USB2.0 interface (e.g. the step S3-2). If the voltage difference between the second VBUS pin 121 and the ID pin 122 of the second electrical plug 12 is equal to a preset voltage value or if the voltage difference between the second VBUS pin 121 and the ID pin 122 of the second electrical plug 12 is neither 5V nor 0V, the interface specification of the first electrical receptacle is judged as an USB power adapter plug interface (e.g. the step S3-3).

Moreover, if the detection unit 3 judges that the interface specification of the first electrical receptacle of the first electrical device is the USB3.0 interface (e.g. the interface specification of the first electrical receptacle of the first electrical device is an A-type USB3.0 interface, a B-type USB3.0 interface, an A-type Micro USB3.0 interface, a B-type Micro USB3.0 interface or an AB-type Micro USB3.0 interface), the first device may provide a current of 900 mA according to the preset settings. Whereas, if the detection unit 3 judges that the interface specification of the first electrical receptacle of the first electrical device is the USB2.0 interface (e.g. the interface specification of the first electrical receptacle of the first electrical device is an A-type USB2.0 interface, a B-type USB2.0 interface, an A-type Micro USB2.0 interface, a B-type Micro USB2.0 interface, an AB-type Micro USB2.0 interface, an A-type Mini USB2.0 interface, a B-type Mini USB2.0 interface or an AB-type Mini USB2.0 interface), the first device may provide a current of 500 mA according to the preset settings. Whereas, if the detection unit 3 judges that the interface specification of the first electrical receptacle of the first electrical device is the USB power adapter plug interface, the first device may provide a specified current according to the preset settings. That is, the magnitude of the specified current is determined according to the resistance value of the resistor 713.

Furthermore, the USB cable 1 of the present invention may additionally provide the function of transmitting a serial signal. For example, any one of a sound source signal, a serial digital signal and a pulse width modulation (PWM) signal may be transmitted between the first electrical device and the second electrical device through the USB3.0 GND_DRAIN pin and the ID pin. At the same time, the USB cable 1 still has the function of performing the USB2.0 transmission.

From the above descriptions, in the USB cable 1 of the present invention, the USB3.0 GND_DRAIN pin 112 of the first electrical plug 11 is connected with the ID pin 122 of the second electrical plug 12. Moreover, the detection unit 3 is disposed within the second electrical device 5. Consequently, the second electrical device 5 can directly judge the interface specification of the first electrical device 4. In comparison with the conventional judging method, the USB interface detection method of the present invention can judge the interface specification of the first electrical device at a faster speed. Moreover, since it is not necessary to install the complicated integrated circuits and wires in the second electrical device 5, the fabricating cost of the USB interface detection device of the present invention is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A USB interface detection device, comprising:
a USB cable comprising
a first electrical plug to be plugged into a first electrical receptacle of a first electrical device, wherein said first electrical plug comprises a first VBUS pin and a USB3.0 GND_DRAIN pin; and
a second electrical plug to be plugged into a second electrical receptacle of a second electrical device, wherein said second electrical plug comprises a second VBUS pin and an ID pin, wherein said second VBUS pin is connected with said first VBUS pin, and said ID pin is connected with said USB3.0 GND_DRAIN pin; and
a detection unit disposed within said second electrical device, wherein when said first electrical plug is plugged into said first electrical receptacle and said second electrical plug is plugged into said second electrical receptacle, said detection unit judges an interface specification of said first electrical receptacle by detecting a voltage value of said second VBUS pin and a voltage value of said ID pin, or said detection unit judges said interface specification of said first electrical receptacle by detecting a voltage difference between said second VBUS pin and said ID pin.

2. The USB interface detection device according to claim 1, wherein a USB interface of said first electrical plug is an A-type USB3.0 interface, a B-type USB3.0 interface, an A-type Micro USB3.0 interface, a B-type Micro USB3.0 interface or an AB-type Micro USB3.0 interface.

3. The USB interface detection device according to claim 1, wherein a USB interface of said second electrical plug is a B-type Micro USB2.0 interface, an A-type Micro USB2.0 interface, an AB-type Micro USB2.0 interface, an A-type Mini USB2.0 interface, a B-type Mini USB2.0 interface, an AB-type Mini USB2.0 interface, an A-type Micro USB3.0 interface, a B-type Micro USB3.0 interface or an AB-type Micro USB3.0 interface.

4. The USB interface detection device according to claim 1, wherein at least one of a sound source signal, a serial digital signal and a pulse width modulation (PWM) signal is transmitted between said first electrical device and said second electrical device through said USB3.0 GND_DRAIN pin and said ID pin.

5. The USB interface detection device according to claim 1, wherein said first electrical device is a current-providing device for providing a current to said second electrical device.

6. The USB interface detection device according to claim 1, wherein said first electrical device is a USB power adapter plug including a resistor, wherein said first electrical device is a current-providing device for providing a current to said second electrical device, wherein a magnitude of said current is determined according to a resistance value of said resistor.

7. The USB interface detection device according to claim 1, wherein when said first electrical plug is plugged into said first electrical receptacle and said second electrical plug is plugged into said second electrical receptacle, if said detection unit detects that said voltage difference between said second VBUS pin and said ID pin is 5V, or if said detection unit detects that said voltage value of said second VBUS pin is 5V and said voltage value of said ID pin is 0V, said interface specification of said first electrical receptacle is a USB3.0 interface.

8. The USB interface detection device according to claim 7, wherein said USB3.0 interface is an A-type USB3.0 interface, a B-type USB3.0 interface, an A-type Micro USB3.0 interface, a B-type Micro USB3.0 interface or an AB-type Micro USB3.0 interface.

9. The USB interface detection device according to claim 1, wherein when said first electrical plug is plugged into said first electrical receptacle and said second electrical plug is plugged into said second electrical receptacle, if said detection unit detects that said voltage difference between said second VBUS pin and said ID pin is 0V, or if said detection unit detects that said voltage value of said second VBUS pin is 5V and said voltage value of said ID pin is 5V, said interface specification of said first electrical receptacle is a USB2.0 interface.

10. The USB interface detection device according to claim 9, wherein said USB2.0 interface is an A-type USB2.0 interface, a B-type USB2.0 interface, an A-type Micro USB2.0 interface, a B-type Micro USB2.0 interface, an AB-type Micro USB2.0 interface, an A-type Mini USB2.0 interface, a B-type Mini USB2.0 interface or an AB-type Mini USB2.0 interface.

11. The USB interface detection device according to claim 1, wherein when said first electrical plug is plugged into said first electrical receptacle and said second electrical plug is plugged into said second electrical receptacle, if said detection unit detects that said voltage difference between said second VBUS pin and said ID pin is equal to a preset voltage value, said interface specification of said first electrical receptacle is a USB power adapter plug.

12. A USB interface detection method for detecting an interface specification of a first electrical receptacle of a first electrical device when said first electrical device is in communication with a second electrical device, said USB interface detection method comprising steps of:
(a) providing a USB cable, wherein said USB cable comprises a first electrical plug and a second electrical plug, wherein said first electrical plug comprises a first VBUS pin and a USB3.0 GND_DRAIN pin, and said second electrical plug comprises a second VBUS pin and an ID pin, wherein said first VBUS pin and said second VBUS pin are connected with each other, and said USB3.0 GND_DRAIN pin and said ID pin are connected with each other; and
(b) when said first electrical plug is plugged into said first electrical receptacle of said first electrical device and said second electrical plug is plugged into said second electrical receptacle of said second electrical device, judging an interface specification of said first electrical receptacle by detecting a voltage value of said second VBUS pin and a voltage value of said ID pin, or judging said interface specification of said first electrical receptacle by detecting a voltage difference between said second VBUS pin and said ID pin.

13. The USB interface detection method according to claim 12, wherein in said step (b), if said voltage difference is 5V or if said voltage value of said second VBUS pin is 5V and said voltage value of said ID pin is 0V, said interface specification of said first electrical receptacle is judged as a USB3.0 interface, wherein if said voltage difference is 0V or if said voltage value of said second VBUS pin is 5V and said voltage value of said ID pin is 5V, said interface specification of said first electrical receptacle is judged as a USB2.0 interface, wherein if said voltage difference is equal to a preset voltage value, said interface specification of said first electrical receptacle is judged as a USB power adapter plug.

14. The USB interface detection method according to claim 13, wherein said USB3.0 interface is an A-type USB3.0 interface, a B-type USB3.0 interface, an A-type Micro USB3.0 interface, a B-type Micro USB3.0 interface or an AB-type Micro USB3.0 interface, wherein said USB2.0 interface is an A-type USB2.0 interface, a B-type USB2.0 interface, an A-type Micro USB2.0 interface, a B-type Micro USB2.0 interface, an AB-type Micro USB2.0 interface, an A-type Mini USB2.0 interface, a B-type Mini USB2.0 interface or an AB-type Mini USB2.0 interface.

15. The USB interface detection method according to claim 13, wherein before said step (b), said USB interface detection method further comprises a step of judging whether said first electrical device is connected with said second electrical device, wherein if said voltage value of said second VBUS pin is 5V, it is determined that said first electrical plug is plugged into said first electrical receptacle and said second electrical plug is plugged into said second electrical receptacle.

16. The USB interface detection method according to claim 12, wherein a USB interface of said first electrical plug is an A-type USB3.0 interface, a B-type USB3.0 interface, an A-type Micro USB3.0 interface, a B-type Micro USB3.0 interface or an AB-type Micro USB3.0 interface.

17. The USB interface detection method according to claim 12, wherein a USB interface of said second electrical plug is an A-type Micro USB2.0 interface, a B-type Micro USB2.0 interface, an AB-type Micro USB2.0 interface, an A-type Mini USB2.0 interface, a B-type Mini USB2.0 interface, an AB-type Mini USB2.0 interface, an A-type Micro USB3.0 interface, a B-type Micro USB3.0 interface or an AB-type Micro USB3.0 interface.

18. A USB cable, comprising:
a first electrical plug to be plugged into a first electrical receptacle of a first electrical device, wherein said first electrical plug comprises a first VBUS pin and a USB3.0 GND_DRAIN pin; and
a second electrical plug to be plugged into a second electrical receptacle of a second electrical device, wherein said second electrical plug comprises a second VBUS pin and an ID pin,
wherein said first VBUS pin and said second VBUS pin are connected with each other, and said USB3.0 GND_DRAIN pin and said ID pin are connected with each other.

19. The USB cable according to claim 18, wherein a USB interface of said first electrical plug is an A-type USB3.0 interface, a B-type USB3.0 interface, an A-type Micro USB3.0 interface, a B-type Micro USB3.0 interface or an AB-type Micro USB3.0 interface.

20. The USB cable according to claim 18, wherein a USB interface of said second electrical plug is an A-type Micro USB2.0 interface, a B-type Micro USB2.0 interface, an AB-type Micro USB2.0 interface, an A-type Mini USB2.0 interface, a B-type Mini USB2.0 interface, an AB-type Mini USB2.0 interface, an A-type Micro USB3.0 interface, a B-type Micro USB3.0 interface or an AB-type Micro USB3.0 interface.
